(19) United States
(12) Patent Application Publication
(10) Pub. No.: US 2025/0383880 A1
(43) Pub. Date: Dec. 18, 2025

(54) METHOD, APPARATUS, DEVICE AND MEDIUM FOR DETERMINING DATA EXCEPTION

(71) Applicant: Lemon Inc., Grand Cayman (KY)

(72) Inventor: Jian Chen, Singapore (SG)

(21) Appl. No.: 19/243,164

(22) Filed: Jun. 19, 2025

Related U.S. Application Data
(63) Continuation of application No. PCT/SG2024/050402, filed on Jun. 18, 2024.

(51) Int. Cl. G06F 9/38; G06F 9/455; G06F 16/21

(52) U.S. Cl. CPC G06F 9/3865; G06F 9/45512; G06F 16/219

(57) ABSTRACT

There are provided a method, apparatus, device and medium for determining a data exception is provided. In the method, a key field in a dataset is determined, the dataset comprising a plurality of data sources, and respective data sources of the plurality of data sources respectively comprising at least one field. A historical state of the key field in a historical time period is obtained. In response to determining that the historical state indicates that a data change in the key field satisfies an exception condition, it is determined that the key field has a data exception, the data exception indicating that the key field has an exception in the historical time period. At least one cause field associated with the data exception is determined in the dataset, a data exception of the at least one cause field resulting in a data exception of the key field.

### CROSS-REFERENCE TO RELATED APPLICATIONS

This application claims priority to Patent Application No. PCT/SG2024/050402, filed with the Intellectual Property Office of Singapore on Jun. 18, 2024, and entitled “METHOD, APPARATUS, DEVICE AND MEDIUM FOR DETERMINING DATA EXCEPTION”, the disclosures of which are incorporated herein by reference in their entireties.

### FIELD

Implementations of the present disclosure generally relate to dataset management, and in particular to, a method, apparatus, device and computer-readable storage medium for determining a data exception in a dataset.

### BACKGROUND

Datasets can be utilized to store a variety of data, such as various application-related data. A plurality of users may install applications on their respective client devices, and large amounts of data will be generated as the users use applications. At this point, the dataset may include a large number of fields from a plurality of data sources. Analysis tasks may be performed on data in the dataset, e.g., determining associations between certain fields, etc. However, exceptions might occur in data in the dataset, which prevents an analysis task from being accurately performed. Generally, an administrator of the dataset needs to manually detect and handle the exception, so as to determine a source of the data exception. At this point, it is desirable to determine a data exception in the dataset in a more accurate and effective way.

### SUMMARY

In a first aspect of the present disclosure, a method for determining a data exception is provided. In the method, a key field in a dataset is determined, the dataset comprising a plurality of data sources, and respective data sources of the plurality of data sources respectively comprising at least one field. A historical state of the key field in a historical time period is obtained. In response to determining that the historical state indicates that a data change in the key field satisfies an exception condition, it is determined that the key field has a data exception, the data exception indicating that the key field has an exception in the historical time period. At least one cause field associated with the data exception is determined in the dataset, a data exception of the at least one cause field resulting in a data exception of the key field.

In a second aspect of the present disclosure, an apparatus for determining a data exception is provided. The apparatus comprises: a field determining module configured for determining a key field in a dataset, the dataset comprising a plurality of data sources, and respective data sources of the plurality of data sources respectively comprising at least one field; a state obtaining module configured for obtaining a historical state of the key field in a historical time period; an exception determining module configured for, in response to determining that the historical state indicates that a data change in the key field satisfies an exception condition, determining that the key field has a data exception, the data exception indicating that the key field has an exception in the historical time period; and a cause determining module configured for determining at least one cause field associated with the data exception in the dataset, a data exception of the at least one cause field resulting in a data exception of the key field.

In a third aspect of the present disclosure, an electronic device is provided. The electronic device comprises: at least one processing unit; and at least one memory, coupled to the at least one processing unit and storing instructions executed by the at least one processing unit, the instructions, when executed by the at least one processing unit, causing the electronic device to perform the method according to the first aspect of the present disclosure.

In a fourth aspect of the present disclosure, a computer-readable storage medium is provided, storing a computer program thereon, the computer program, when executed by a processor, causing the processor to implement the method according to the first aspect of the present disclosure.

In a fifth aspect of the present disclosure, a computer program product is provided, comprising a computer program, wherein the computer program, when executed by a processor, implements the method according to the first aspect of the present disclosure.

It should be understood that what is described in this Summary is not intended to identify key features or essential features of the implementations of the present disclosure, nor is it intended to limit the scope of the present disclosure. Other features disclosed herein will become easily understandable through the following description.

### BRIEF DESCRIPTION OF THE DRAWINGS

The above and other features, advantages, and aspects of respective implementations of the present disclosure will become more apparent from the following detailed description with reference to the accompanying drawings. The same or similar reference numerals represent the same or similar elements throughout the figures, where:

FIG. 1 illustrates a block diagram of an example environment for determining a data exception;

FIG. 2 illustrates a block diagram for determining a data exception according to some implementations of the present disclosure;

FIG. 3 illustrates a block diagram of a module for determining a data exception according to some implementations of the present disclosure;

FIG. 4 illustrates a block diagram for determining key fields according to some implementations of the present disclosure;

FIG. 5 illustrates a block diagram of a page for providing information regarding a data exception according to some implementations of the present disclosure;

FIG. 6 illustrates a block diagram of mapping relationships between respective fields according to some implementations of the present disclosure;

FIG. 7 illustrates a flowchart of a method for determining a data exception according to some implementations of the present disclosure;

FIG. 8 illustrates a block diagram of an apparatus for determining a data exception according to some implementations of the present disclosure; and

FIG. 9 illustrates a block diagram of a device capable of implementing a plurality of implementations of the present disclosure.

### DETAILED DESCRIPTION

The implementations of the present disclosure will be described in more detail with reference to the accompanying drawings, in which some implementations of the present disclosure have been illustrated. However, it should be understood that the present disclosure can be implemented in various manners, and thus should not be construed to be limited to implementations disclosed herein. On the contrary, those implementations are provided for the thorough and complete understanding of the present disclosure. It should be understood that the drawings and implementations of the present disclosure are only used for illustration, rather than limiting the protection scope of the present disclosure.

As used herein, the term “comprise” and its variants are to be read as open terms that mean “include, but is not limited to.” The term “based on” is to be read as “based at least in part on.” The term “one implementation” or “the implementation” is to be read as “at least one implementation.” The term “some implementations” is to be read as “at least some implementations.” Other definitions, explicit and implicit, might be further included below. As used herein, the term “model” may represent associations between respective data. For example, the above association may be obtained based on various technical solutions that are currently known and/or to be developed in future.

It is to be understood that the data involved in this technical solution (including but not limited to the data itself, data acquisition or use) should comply with the requirements of corresponding laws and regulations and relevant provisions.

It is to be understood that, before applying the technical solutions disclosed in respective embodiments of the present disclosure, the user should be informed of the type, scope of use, and use scenario of the personal information involved in the present disclosure in an appropriate manner in accordance with relevant laws and regulations, and user authorization should be obtained.

For example, in response to receiving an active request from the user, prompt information is sent to the user to explicitly inform the user that the requested operation would acquire and use the user's personal information. Therefore, according to the prompt information, the user may decide on his/her own whether to provide the personal information to the software or hardware, such as electronic devices, applications, servers, or storage media that perform operations of the technical solutions of the present disclosure.

As an optional but non-limiting implementation, in response to receiving an active request from the user, the way of sending the prompt information to the user may, for example, include a pop-up window, and the prompt information may be presented in the form of text in the pop-up window. In addition, the pop-up window may also carry a select control for the user to choose to “agree” or “disagree” to provide the personal information to the electronic device.

It is to be understood that the above process of notifying and obtaining the user authorization is only illustrative and does not limit the implementations of the present disclosure. Other methods that satisfy relevant laws and regulations are also applicable to the implementations of the present disclosure.

As used herein, the term “in response to” indicates a state in which a corresponding event occurs or a condition is satisfied. It is to be understood that the timing of the execution of a subsequent action that is performed in response to the event or condition is not necessarily strongly correlated to the time at which the event or condition occurs or is established. For example, in some cases, the subsequent action may be performed immediately upon occurrence of the event or upon satisfaction of the condition. In other cases, the subsequent action may be performed only after a period of time since the event occurs or the condition is established.

### Example Environment

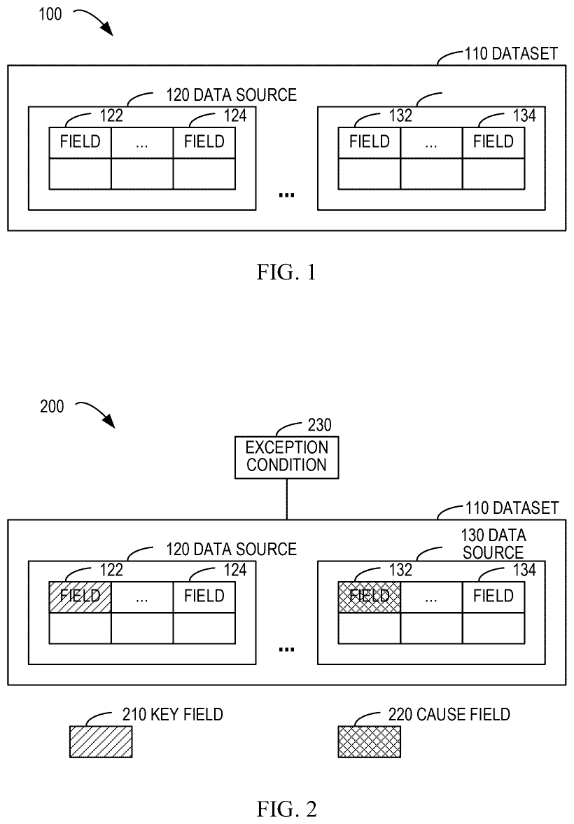

A plurality of technical solutions for dataset management have been proposed so far, and various application-related data can be stored using datasets. A plurality of users may install applications on their respective client devices, and large amounts of data will be generated as the users use applications. A dataset may include a large number of fields from a plurality of data sources. An application environment according to some implementations of the present disclosure is described with reference to FIG. 1, which illustrates a block diagram 100 of an application environment in which data exceptions are determined. As shown in FIG. 1, a dataset 110 may include a plurality of data sources 120, . . . , and 130. Each data source may include one or more fields, for example, the data source 120 may include fields 122, . . . , and 124, and the data source 130 may include fields 132, . . . , and 134, etc.

Analysis tasks may be performed on data in the dataset, e.g., determining associations between some fields, and so on. However, an exception might occur in data in the dataset, which prevents an analysis task from being accurately performed. Generally, an administrator of the dataset needs to manually discover and handle the exception, so as to determine a cause of the exception. At this point, it is desirable to determine a data exception in the dataset in a more accurate and effective way.

### Summary of Determining Data Anomaly

In order to at least partially solve the shortcomings in the prior art, a method for determining a data exception is provided according to one implementation of the present disclosure. A summary of one implementation according to the present disclosure is described with reference to FIG. 2, which illustrates a block diagram 200 for determining a data exception according to some implementations of the present disclosure. As shown in FIG. 2, the dataset 110 may include a plurality of data sources 120, . . . , 130, and individual data sources of the plurality of data sources may respectively include at least one field. A key field in the dataset 110 may be determined, and a key field 210 may be represented using a diagonal box, where a field 122 is a key field.

The dataset 110 may be continually updated over time, and a historical state of the key field over a historical period of time may be obtained. Further, the historical state may be analyzed to determine whether a data exception exists in the key field. In response to determining that the historical state indicates that a change in data in the key field satisfies an exception condition, it may be determined that a data exception exists in the key field, where the data exception indicates that an exception occurs in the key field within a historical period of time. A specific exception condition may be specified according to a specific application environment, for example, a threshold amplitude of data fluctuation, a threshold period length of data fluctuation, and the like may be specified.

Further, at least one cause field associated with the data exception may be determined in the dataset, the data exception of the at least one cause field resulting in a data exception of the key field. For example, a cause field 220 may be represented by using a grid line box, at which point the field 132 is a cause field. Here, the cause field is a cause for the data exception of the key field, that is, the data exception of the cause field causes the data exception of the key field. With implementations of the present disclosure, data in respective fields in a dataset may be dynamically managed, and it may be automatically determined whether an exception occurs in a key field that a user concerns, as well as the specific cause of the exception. In this way, the complexity of the manual management can be reduced, and the management efficiency of the dataset can be improved.

### Detailed Process of Determining Data Exception

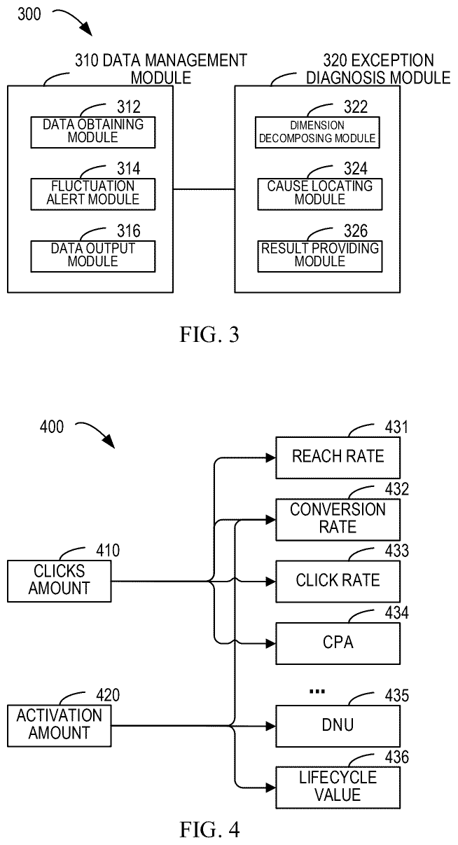

Having described the summary according to some implementations of the present disclosure, more information regarding determining data exceptions will be described with reference to FIG. 3. This figure illustrates a block diagram 300 of a module for determining a data exception according to some implementations of the present disclosure. As shown in FIG. 3, a data management module 310 may be utilized to obtain data of interest from a dataset, and perform further management. Specifically, a data obtaining module 312 may extract one or more important data metrics (for example, key fields) from an existing dataset, and then provide alerts by observing fluctuations of the data metrics.

Because the respective key fields can cover most of the fluctuations of the service exception scenario, various exceptions can be analyzed during the service process. A fluctuation alert module 314 may present an alert based on the fluctuation in real time and visually present the alert. This allows the recipient to observe, in a straightforward way, a key field and a time period over which the fluctuating alert occurs. A data output module 316 may determine a name of the key field and a time of occurrence as an output of the data management module 310 and input them to an exception diagnosis module 320.

Further, the exception diagnosis module 320 may be responsible for a diagnosing a related task and providing a diagnosis result. Specifically, after receiving a key field name and an exception time period from the upstream, a dimension decomposing module 322 may automatically decompose the key field into a plurality of fields in an enumeration way. Further, a cause locating module 324 may look for one or more cause fields from the plurality of fields. In particular, a data script can be run to analyze under which specific dimension the data fluctuations of the alert time period occur. By means of a pre-obtained dimension tracing table, a relevant field of a data source is found. Finally, a result providing module 326 may provide a diagnosis result and a fluctuation alert together to a relevant person, for example, an administrator of the dataset or a person starting to perform a specific task in the dataset.

More details of the respective modules will be described with reference to the figures. According to some implementations of the present disclosure, a dataset may store a variety of data. For example, in an application environment that manages application data, a provider of the application may launch the application, and a plurality of users may download the application and install the application at their respective client devices. A media item can be provided to the respective client devices via the application, and a user can interact with the media item to produce various types of events.

In this application environment, the dataset is used to store data associated with a client device of the plurality of client devices. A plurality of fields can include a first plurality of attributes of the client device (e.g., a region in which the device is located, an operating system type of the device, a version number of an operating system of the device), etc.), a second plurality of attributes of the application installed to the client device (e.g., the application's name, identification, version number, etc.), a third plurality of attributes of the data item sent to the client device via the application (the data item's identification, type, origin, provider, etc.), and a fourth plurality of events associated with the data item (e.g., a click event, a commenting event, a reposting event, a conversion event, etc.). In this way, a variety of attributes involved during the running of the application can be recorded completely, thereby facilitating an improvement in the management efficiency of the application.

According to some implementations of the present disclosure, during identifying the key field in the dataset, among the plurality of fields included in the dataset, candidate fields in the dataset to be observed can be determined based on user requirements. Specifically, one or more key fields can be defined and collected according to service requirements and experience. These fields have a direct and profound impact on the service, and thus can be used as a data basis to measure whether an exception occurs in various data collected during the running process of the application. For example, the candidate fields may include the user conversion rate, clicks, resource overhead, etc.

According to some implementations of the present disclosure, among the plurality of fields of the dataset, an upstream field affecting the candidate field may be determined, and the upstream field is determined as the key field. Specifically, in order to save data storage costs and relieve computation pressure, while ensuring that the key fields concerned are clear and understandable, more basic fields are searched for in the upstream fields so as to reduce the absolute number of key fields. Dependencies between various fields can be determined, for example, a relevant calculation formula of various fields can be obtained, and then fields of variables involved in the formula are used as upstream fields.

More details are described with reference to FIG. 4, which illustrates a block diagram 400 for determining key fields according to some implementations of the present disclosure. As illustrated in FIG. 4, a field 431 indicates a “reach rate” and is calculated based on “clicks” in a field 410, so the field 410 is an upstream field of the field 431. The field 410 is an upstream field of fields 432, 433, 434. That is, assuming that the candidate field indicates a reach rate, a conversion rate and a click rate, it may be determined that the key field is the field 410, that is, clicks. Similarly, a field 420 (activation amount) is an upstream field of fields 432, 435, 436. That is, assuming that the candidate field indicates the conversion rate, and cycle value, it can be determined that the key field is the field 420, i.e., the activation amount. In this way, the number of detected fields may be reduced, thereby reducing various relevant resource overheads.

According to some implementations of the present disclosure, in the process of determining key fields in the dataset, a task to be performed in the dataset may be obtained, where the task is to determine an association between the fourth plurality of events. Further, a key field associated with the task may be determined among the plurality of fields included in the dataset.

For the sake of description, more details of determining a key field will be described only by taking the execution of a judgment task as an example. In this case, for a judgment task, the key field may further include device identification information and the like. Since the foregoing information directly affects a judgment result, a key field is determined based on the foregoing information, and an exception field that might cause a data judgment exception can be found more accurately, thereby improving accuracy of subsequent data judgment.

According to some implementations of the present disclosure, in the process of obtaining a historical state of a key field in a historical time period, an automation script may be used to extract the historical state from the plurality of fields included in the dataset. In particular, an executable script can be pre-built to extract the historical state of a key field of concern from the dataset. For example, a name of the key field, a time period to be processed (i.e., the period of concern, e. g., the past 1 day, 2 days, one week, etc.) may be specified, and then corresponding data is obtained. For example, the script described above may be periodically executed, and an extraction result may be stored in a specified data table.

According to some implementations of the present disclosure, the key fields may be managed in real time through a set of predetermined rules and setting thresholds, and the setting of the thresholds may be dynamically changed automatically with the elapse of time. The management system performs a data comparative analysis at the end of each data capturing cycle, and when the data fluctuation of a certain indicator exceeds a pre-set threshold value, the system automatically triggers an alert mechanism.

According to some implementations of the present disclosure, the exception condition may specify at least one of: an amplitude threshold for determining a data exception, or a duration threshold for determining a data exception. An amplitude threshold may be specified in advance, and the amplitude threshold may represent a floating range of data fluctuation. When the data fluctuation exceeds the range, it is considered that a data exception occurs; and when the data fluctuation is within the range, it is considered that no data exception occurs. The amplitude threshold may be specified using an absolute number or a relative number. Assuming that the key field is clicks, the amplitude threshold may be represented, for example, as N (a positive integer). At this point, when clicks float upwards or downwards by more than N, it is considered that an exception occurs. Alternatively and/or additionally, the amplitude threshold may be represented as M % (M is a number within 100). At this point, when clicks float upwards or downwards by more than M %, it is considered that an exception occurs.

Alternatively and/or additionally, a duration threshold may be specified in advance, where the duration threshold may represent a time range of data fluctuation. When the data fluctuation involves a long time period and exceeds the range, it is considered that a data exception occurs; and when the data only fluctuates within a short time period and is within the range, it is considered that no data exception occurs. The duration threshold may be specified using an absolute number or a relative number. For example, the threshold may be specified as 10 minutes, 30 minutes, 1% of the cycle of concern, or other numerical value, etc.

In this way, an exception judgment condition regarding whether a data exception occurs can be conveniently adjusted, so that the exception judgment condition can be flexibly adjusted based on a specific application environment. In particular, assuming that the history data indicates that user clicks on weekends and holidays will increase significantly, at this point the amplitude threshold for weekends and holidays may increase to some extent, etc.

In the event that there exists a data exception, alert information may be provided. The alert information may include a name of a key field, a time period when the data exception occurs, a fluctuation amplitude relative to historical data, and other exception information. According to some implementations of the present disclosure, an exception page associated with a data exception is provided. The exception page comprises a filter parameter for presenting the data exception. The filter parameter comprises at least one of: a time range of the data exception, an application involved in the data exception, a region involved in the data exception, a data item type involved in the data exception, and a source involved in the data exception. Further, in response to receiving an interaction for the filter parameter, the exception page is updated.

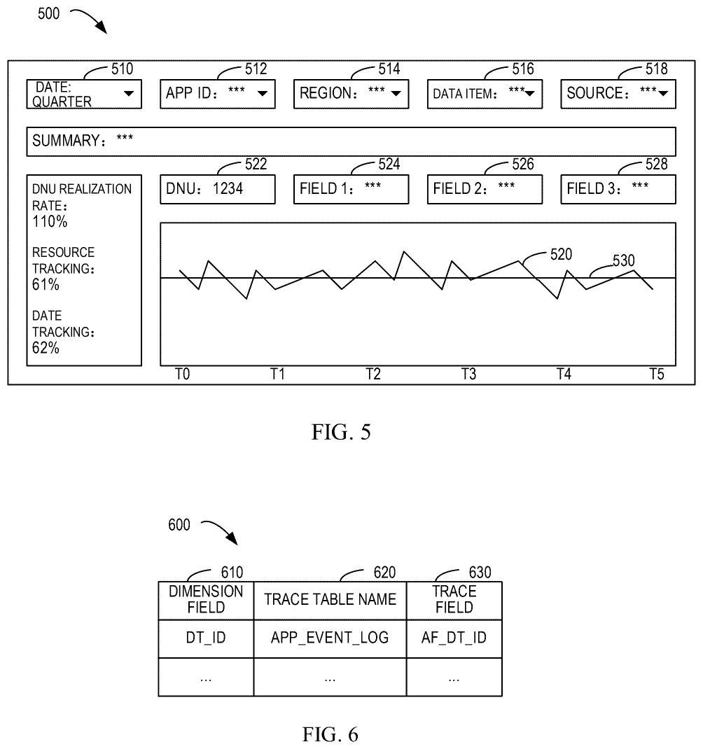

More details regarding providing exception information are described with reference to FIG. 5, which illustrates a block diagram of a page 500 for providing information regarding a data exception according to some implementations of the present disclosure. As shown in FIG. 5, information regarding a plurality of key fields may be presented in a page 500. For example, a control 522 may correspond to the key field “User Quantity”, and the user may press the control 522 to view relevant information of the user quantity. Similarly, controls 524, 526, 528 and the like may correspond to other pluralities of key fields, respectively. Given that the user selects the control 522, a fluctuation curve 520 of the user quantity data may be presented, and a historical average 530 of the user quantity data may be presented.

According to some implementations of the present disclosure, potential exception fields affected by the key field may be determined in the dataset; and potential exception data associated with the potential exception field may be provided. As shown in FIG. 5, the page 500 may further present other information about the user quantity, such as a user quantity achievement rate (i.e., a ratio between a current user quantity and a predicted user quantity), resource tracking (i.e., a ratio between resources currently used and scheduled resources), date tracking (i.e., a ratio between the time period during which the current page is presented and the time period to be observed), etc. In this way, information about other fields related to a key field that may be affected by the key field may be automatically provided, so as to enable the user to be fully aware of the data in the dataset.

The page 500 may further include a plurality of filter parameters. For example, the user may press a control 510 to select a time range for a data exception, e.g., the data exception may be presented by length of time, e. g., quarter, month, day, etc. The user can press a control 512 to present a data exception related to a certain application, the user can press a control 514 to present a data exception related to a certain region (e.g., city A, city B, etc.), the user can press a control 516 to present exceptions related to a certain type of data item presented in the application, the user can press a control 518 to select sources involved in exception data, etc. In this way, it may be convenient to specify the exception data desired to be presented from a plurality of angles, thereby supporting the user obtaining more information. It should be understood that the specific content of the page 500 is merely illustrative and that the page 500 may present more, less, or different information.

While the various steps performed by the data management module 310 have been described, more information of the exception diagnosis module 320 will be described below. According to some implementations of the present disclosure, upon detecting a data exception of a key field, the exception diagnosis module 320 may be invoked to determine at least one cause field in the dataset that is associated with the data exception. Specifically, the at least one cause field may be determined using an automation script, and the automation script describes a mapping relationship between the key field and the at least one cause field. For example, the exception diagnosis module 320 may receive the name of the key field and related information for the time period in which the exception occurred, and then invoke the dimension decomposing module 322 to automatically decompose the related dimensions.

The exception diagnosis module 320 may invoke a predefined data script to execute a corresponding process. For example, the dimension decomposing module may automatically analyze the fields for various dimensions in the dataset based on the key fields. Specifically, for the dimension of a client device, a region where the device is located, an operating system type of the device, a version number of an operating system of the device, and the like may be enumerated. For the dimension of an application installed to a client device, name, identification, version number and the like of the application may be enumerated. For the dimension of a data item that is published to the client device via the application, the identification, type, source, provider and the like of the data item may be enumerated. For the event dimension associated with data items, a click event, a commenting event, a forwarding event, a conversion event and the like may be enumerated. In this way, a key field in which a data exception occurs may be automatically obtained as a finer-dimension field, thereby facilitating searching for a cause field that causes the data exception in a dataset.

Further, the cause field causing the data exception can be located from the various fields after decomposing. It should be understood that a plurality of data sources can be included in the dataset, and the names of the fields in different data sources can be different. For example, in one data source, the name of the field may be represented as “DT_ID”; whereas in another data source, the name of the field including the same content may be represented as “AF_DT_ID”. In this case, it cannot be confirmed only based on the field name that the two fields correspond to the same data item, and a mapping relationship needs to be established between the fields.

More information is described with reference to FIG. 6, which illustrates a block diagram of mapping relationships 600 between respective fields according to some implementations of the present disclosure. As shown in FIG. 6, a dimension field 610 represents a decomposed dimension field (a “data item” field “DT_ID” obtained by decomposing the key field), a trace table name 620 represents a name of another data source determined through a tracing process, and a trace field 630 represents a field name of a “data item” in a data table “APP_EVENT_LOG” is “AF_DT_ID”. In this way, a mapping relationship may be established between the field “DT_ID” in one data source and the field “AF_DT_ID” in another data source. In other words, the content stored in the two fields is “data item” despite the fact that the names of the two fields are different.

It should be understood that although FIG. 6 only schematically illustrates one example of a mapping relationship between fields, alternatively and/or additionally, the mapping relationship 600 may include more rows, and each row may describe one mapping relationship. For example, another mapping relationship may indicate that a field “APP ID” in one data source corresponds to a field “AF_APP_ID” in another data source “APP_EVENT_LOG”. In this way, it is possible to support quick finding of the cause field in an automation script.

Further, it may be determined whether there is an exception in the data in respective found cause fields. In response to determining that there is an exception in the data in a cause field of the at least one cause field, an exception state associated with the key field and the cause field may be provided. Specifically, if it is found that there is an exception in the data in the cause field (for example, the data exceeds a normal threshold range, or the length of a time period in which the exception occurs exceeds an allowable threshold length of time), it may be determined that there is an exception in the cause field. In this case, an exception state may be provided to the user, that is, an exception state of the key field and an exception state of each cause field found through a source tracing process are provided. In this manner, a greater amount of information may be provided to the administrator of the dataset, supporting subsequent operations of the administrator.

According to some implementations of the present disclosure, a corresponding alert condition may be specified for different fields. Here, the alert condition may include at least one of: a duration of an exception satisfies a threshold time length, and an amplitude of the exception satisfies a threshold amplitude change. Further, exception states associated with the key field and the cause field may be provided in response to determining that the exceptions of respective fields meet the alert condition. In this way, an exception alert can be presented in a more flexible and effective manner, so that the administrator of the dataset can find an association between various exception fields, thereby improving the accuracy of performing an attribution task.

With example implementations of the present disclosure, the upstream field may be determined by a specific calculation formula for respective key fields, thereby reducing the number of fields to be processed. The alert threshold can be set dynamically, and thus the fluctuation can be defined according to requirements, thereby effectively reducing the number of alerts and improving the efficiency of detecting exceptions. Further, the visual page can provide optional dynamic indicators, thereby effectively reducing the complexity of manual operation. By establishing a dimension tracing table, direct tracing of abnormal dimensions can be implemented, thereby supporting the administrator of the dataset to have a comprehensive knowledge of respective exceptions in the dataset.

### Example Process

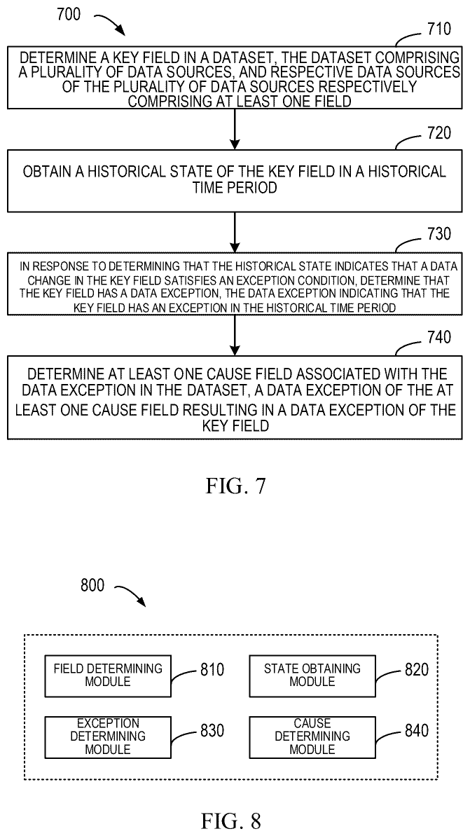

FIG. 7 illustrates a flowchart of a method 700 for determining a data exception according to some implementations of the present disclosure. At block 710, a key field in a dataset is determined, the dataset comprising a plurality of data sources, and respective data sources of the plurality of data sources respectively comprising at least one field. At block 720, a historical state of the key field in a historical time period is obtained. At block 730, in response to determining that the historical state indicates that a data change in the key field satisfies an exception condition, it is determined that the key field has a data exception, the data exception indicating that the key field has an exception in the historical time period. At block 740, at least one cause field associated with the data exception is determined in the dataset, a data exception of the at least one cause field resulting in a data exception of the key field.

According to some implementations of the present disclosure, determining the key field in the dataset comprises: determining, among a plurality of fields comprised in the dataset, a candidate field in the dataset to be observed based on user requirements; determining, among the plurality of fields, an upstream field affecting the candidate field; and determining the upstream field as the key field.

According to some implementations of the present disclosure, obtaining the historical state of the key field in the historical time period comprises: extracting the historical state from a plurality of fields comprised in a dataset by using an automation script.

According to some implementations of the present disclosure, the exception condition specifies at least one of: an amplitude threshold for determining the data exception, or a duration threshold for determining the data exception.

According to some implementations of the present disclosure, the method further comprises: providing an exception page associated with the data exception, wherein the exception page comprises a filter parameter for presenting the data exception, and the filter parameter comprises at least one of: a time range of the data exception, an application involved in the data exception, a region involved in the data exception, a data item type involved in the data exception, and a source involved in the data exception; and updating the exception page in response to receiving an interaction for the filter parameter.

According to some implementations of the present disclosure, determining, in the dataset, the at least one cause field associated with the data exception comprises: determining the at least one cause field by using an automation script, the automation script describing a mapping relationship between the key field and the at least one cause field; and the method further comprises: in response to determining that data in a cause field of the at least one cause field has an exception, providing an exception state associated with the key field and the cause field.

According to some implementations of the present disclosure, providing the exception state associated with the key field and the cause field comprises: providing the exception state in response to determining at least one of: a duration length of the exception satisfying a threshold length, and an amplitude change of the exception satisfying a threshold amplitude change.

According to some implementations of the present disclosure, the method further comprises: determining, in the dataset, a potential exception field affected by the key fields; and providing potential exception data associated with the potential exception field.

According to some implementations of the present disclosure, the dataset is for storing data associated with a client device of a plurality of client devices, and the plurality of fields comprise a first plurality of attributes of the client device, a second plurality of attributes of an application installed to the client device, a third plurality of attributes of a data item published to the client device via the application, and a fourth plurality of events associated with the data item.

According to some implementations of the present disclosure, determining the key field in the dataset further comprises: obtaining a task to be performed in the dataset, the task being to determine an association between the fourth plurality of events; and determining a key field associated with the task among a plurality of fields comprised in the dataset.

### Example Apparatus and Device

FIG. 8 illustrates a block diagram of an apparatus 800 for determining a data exception according to some implementations of the present disclosure. The apparatus 800 comprises: a field determining module 810 configured for determining a key field in a dataset, the dataset comprising a plurality of data sources, and respective data sources of the plurality of data sources respectively comprising at least one field; a state obtaining module 820 configured for obtaining a historical state of the key field in a historical time period; an exception determining module 830 configured for, in response to determining that the historical state indicates that a data change in the key field satisfies an exception condition, determining that the key field has a data exception, the data exception indicating that the key field has an exception in the historical time period; and a cause determining module 840 configured for determining at least one cause field associated with the data exception in the dataset, a data exception of the at least one cause field resulting in a data exception of the key field.

According to some implementations of the present disclosure, the field determining module is further configured for: determining, among a plurality of fields comprised in the dataset, a candidate field in the dataset to be observed based on user requirements; determining, among the plurality of fields, an upstream field affecting the candidate field; and determining the upstream field as the key field.

According to some implementations of the present disclosure, the state obtaining module is further configured for: extracting the historical state from a plurality of fields comprised in a dataset by using an automation script.

According to some implementations of the present disclosure, the exception condition specifies at least one of: an amplitude threshold for determining the data exception, or a duration threshold for determining the data exception.

According to some implementations of the present disclosure, the apparatus further comprises: a page providing module configured for providing an exception page associated with the data exception, wherein the exception page comprises a filter parameter for presenting the data exception, and the filter parameter comprises at least one of: a time range of the data exception, an application involved in the data exception, a region involved in the data exception, a data item type involved in the data exception, and a source involved in the data exception; and a page updating module configured for updating the exception page in response to receiving an interaction for the filter parameter.

According to some implementations of the present disclosure, the cause determining module is further configured for: determining the at least one cause field by using an automation script, the automation script describing a mapping relationship between the key field and the at least one cause field.

According to some implementations of the present disclosure, the apparatus further comprises: a providing module configured for, in response to determining that data in a cause field of the at least one cause field has an exception, providing an exception state associated with the key field and the cause field.

According to some implementations of the present disclosure, the providing module is further configured for: providing the exception state in response to determining at least one of: a duration length of the exception satisfying a threshold length, and an amplitude change of the exception satisfying a threshold amplitude change.

According to some implementations of the present disclosure, the apparatus further comprises: a potential exception determining module configured for determining, in the dataset, a potential exception field affected by the key fields; and a potential exception providing module configured for providing potential exception data associated with the potential exception field.

According to some implementations of the present disclosure, the dataset is for storing data associated with a client device of a plurality of client devices, and the plurality of fields comprise a first plurality of attributes of the client device, a second plurality of attributes of an application installed to the client device, a third plurality of attributes of a data item published to the client device via the application, and a fourth plurality of events associated with the data item.

According to some implementations of the present disclosure, the field determining module is further configured for: obtaining a task to be performed in the dataset, the task being to determine an association between the fourth plurality of events; and determining a key field associated with the task among a plurality of fields comprised in the dataset.

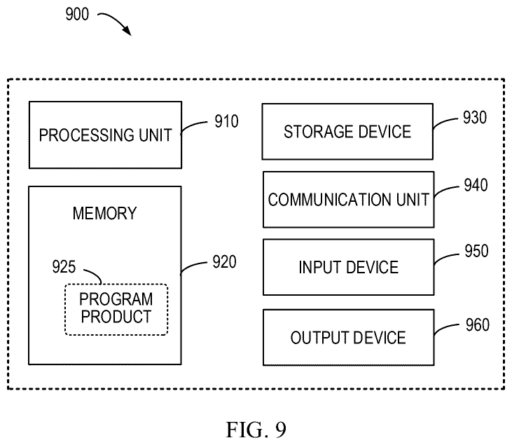

FIG. 9 illustrates a block diagram of a device 900 that can implement a plurality of implementations of the present disclosure. It should be understood that the computing device 900 shown in FIG. 9 is only exemplary and shall not constitute any limitation on the functions and scope of the implementations described herein. The computing device 900 shown in FIG. 9 can be used to implement the method described above.

As shown in FIG. 9, the computing device 900 is in the form of a general purpose computing device. Components of the computing device 900 may include, but are not limited to, one or more processors or processing units 910, a memory 920, a storage device 930, one or more communication units 940, one or more input devices 950, and one or more output devices 960. The processing unit 910 may be a physical or virtual processor and may execute various processing based on the programs stored in the memory 920. In a multi-processor system, a plurality of processing units executes computer-executable instructions in parallel to enhance parallel processing capability of the computing device 900.

The computing device 900 usually includes a plurality of computer storage mediums. Such mediums may be any attainable medium accessible by the computing device 900, including but not limited to, a volatile and non-volatile medium, a removable and non-removable medium. The memory 920 may be a volatile memory (e.g., a register, a cache, a Random Access Memory (RAM)), a non-volatile memory (such as, a Read-Only Memory (ROM), an Electrically Erasable Programmable Read-Only Memory (EEPROM), flash), or any combination thereof. The storage device 930 may be a removable or non-removable medium, and may include a machine-readable medium (e.g., a memory, a flash drive, a magnetic disk) or any other medium, which may be used for storing information and/or data (e.g., training data for training) and be accessed within the computing device 900.

The computing device 900 may further include additional removable/non-removable, volatile/non-volatile storage mediums. Although not shown in FIG. 10, there may be provided a disk drive for reading from or writing into a removable and non-volatile disk (e.g., “floppy disk”) and an optical disc drive for reading from or writing into a removable and non-volatile optical disc. In such cases, each drive may be connected to a bus (not shown) via one or more data medium interfaces. The memory 920 may include a computer program product 925 having one or more program modules, and these program modules are configured for performing various methods or acts of various implementations of the present disclosure.

The communication unit 940 implements communication with another computing device via a communication medium. Additionally, functions of components of the computing device 900 may be realized by a single computing cluster or a plurality of computing machines, and these computing machines may communicate through communication connections. Therefore, the computing device 900 may operate in a networked environment using a logic connection to one or more other servers, a Personal Computer (PC) or a further general network node.

The input device 950 may be one or more various input devices, such as a mouse, a keyboard, a trackball, a voice-input device, and the like. The output device 960 may be one or more output devices, e.g., a display, a loudspeaker, a printer, and so on. The computing device 900 may also communicate through the communication unit 940 with one or more external devices (not shown) as required, where the external device, e.g., a storage device, a display device, and so on, communicates with one or more devices that enable users to interact with the computing device 900, or with any device (such as a network card, a modem, and the like) that enable the computing device 900 to communicate with one or more other computing devices. Such communication may be executed via an Input/Output (I/O) interface (not shown).

According to the example implementations of the present disclosure, a computer-readable storage medium is provided, on which computer-executable instructions are stored, wherein the computer-executable instructions are executed by a processor to implement the method described above. According to the example implementations of the present disclosure, a computer program product is further provided, which is tangibly stored on a non-transient computer-readable medium and includes computer-executable instructions, which are executed by a processor to implement the method described above. According to the example implementations of the present disclosure, a computer program product is provided, storing a computer program thereon, the program, when executed by a processor, implementing the method described above.

Aspects of the present disclosure are described herein with reference to flowchart illustrations and/or block diagrams of methods, apparatus (systems), and computer program products according to implementations of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods and computer program products according to various implementations of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various implementations of the present disclosure have been presented for purposes of illustration, but are not intended to be exhaustive or limited to implementations disclosed. Many modifications and variations will be apparent to those of ordinary skill in the art without departing from the scope and spirit of the described implementations. The terminology used herein was chosen to best explain the principles of implementations, the practical application or technical improvement over technologies found in the marketplace, or to enable others of ordinary skill in the art to understand implementations disclosed herein.

What is claimed is:

1. A method for determining a data exception, comprising:
determining a key field in a dataset, the dataset comprising a plurality of data sources, and respective data sources of the plurality of data sources respectively comprising at least one field;
obtaining a historical state of the key field in a historical time period;
in response to determining that the historical state indicates that a data change in the key field satisfies an exception condition, determining that the key field has a data exception, the data exception indicating that the key field has an exception in the historical time period; and
determining at least one cause field associated with the data exception in the dataset, a data exception of the at least one cause field resulting in a data exception of the key field.

2. The method of claim 1, wherein determining the key field in the dataset comprises:
determining, among a plurality of fields comprised in the dataset, a candidate field in the dataset to be observed based on user requirements;
determining, among the plurality of fields, an upstream field affecting the candidate field; and
determining the upstream field as the key field.

3. The method of claim 1, wherein obtaining the historical state of the key field in the historical time period comprises: extracting the historical state from a plurality of fields comprised in the dataset by using an automation script.

4. The method of claim 1, wherein the exception condition specifies at least one of: an amplitude threshold for determining the data exception, or a duration threshold for determining the data exception.

5. The method of claim 1, further comprising:
providing an exception page associated with the data exception, wherein the exception page comprises a filter parameter for presenting the data exception, and the filter parameter comprises at least one of: a time range of the data exception, an application involved in the data exception, a region involved in the data exception, a data item type involved in the data exception, and a source involved in the data exception; and
updating the exception page in response to receiving an interaction for the filter parameter.

6. The method of claim 1, wherein determining, in the dataset, the at least one cause field associated with the data exception comprises: determining the at least one cause field by using an automation script, the automation script describing a mapping relationship between the key field and the at least one cause field; and
the method further comprises: in response to determining that data in a cause field of the at least one cause field has an exception, providing an exception state associated with the key field and the cause field.

7. The method of claim 6, wherein providing the exception state associated with the key field and the cause field comprises: providing the exception state in response to determining at least one of: a duration length of the exception satisfying a threshold length, and an amplitude change of the exception satisfying a threshold amplitude change.

8. The method of claim 1, further comprising:
determining, in the dataset, a potential exception field affected by the key fields; and
providing potential exception data associated with the potential exception field.

9. The method of claim 1, wherein the dataset is for storing data associated with a client device of a plurality of client devices, and the plurality of fields comprise a first plurality of attributes of the client device, a second plurality of attributes of an application installed to the client device, a third plurality of attributes of a data item published to the client device via the application, and a fourth plurality of events associated with the data item.

10. The method of claim 9, wherein determining the key field in the dataset further comprises:
obtaining a task to be performed in the dataset, the task being to determine an association between the fourth plurality of events; and
determining a key field associated with the task among a plurality of fields comprised in the dataset.

11. An electronic device, comprising:
at least one processing unit; and
at least one memory coupled to the at least one processing unit and storing instructions executed by the at least one processing unit, the instructions, when executed by the at least one processing unit, causing the electronic device to perform a method, comprising:
determining a key field in a dataset, the dataset comprising a plurality of data sources, and respective data sources of the plurality of data sources respectively comprising at least one field;
obtaining a historical state of the key field in a historical time period;
in response to determining that the historical state indicates that a data change in the key field satisfies an exception condition, determining that the key field has a data exception, the data exception indicating that the key field has an exception in the historical time period; and
determining at least one cause field associated with the data exception in the dataset, a data exception of the at least one cause field resulting in a data exception of the key field.

12. The device of claim 11, wherein determining the key field in the dataset comprises:
determining, among a plurality of fields comprised in the dataset, a candidate field in the dataset to be observed based on user requirements;
determining, among the plurality of fields, an upstream field affecting the candidate field; and
determining the upstream field as the key field.

13. The device of claim 11, wherein obtaining the historical state of the key field in the historical time period comprises: extracting the historical state from a plurality of fields comprised in the dataset by using an automation script.

14. The device of claim 11, wherein the exception condition specifies at least one of: an amplitude threshold for determining the data exception, or a duration threshold for determining the data exception.

15. The device of claim 11, wherein the method further comprises:
providing an exception page associated with the data exception, wherein the exception page comprises a filter parameter for presenting the data exception, and the filter parameter comprises at least one of: a time range of the data exception, an application involved in the data exception, a region involved in the data exception, a data item type involved in the data exception, and a source involved in the data exception; and
updating the exception page in response to receiving an interaction for the filter parameter.

16. The device of claim 11, wherein determining, in the dataset, the at least one cause field associated with the data exception comprises: determining the at least one cause field by using an automation script, the automation script describing a mapping relationship between the key field and the at least one cause field; and
the method further comprises: in response to determining that data in a cause field of the at least one cause field has an exception, providing an exception state associated with the key field and the cause field.

17. The device of claim 16, wherein providing the exception state associated with the key field and the cause field comprises: providing the exception state in response to determining at least one of: a duration length of the exception satisfying a threshold length, and an amplitude change of the exception satisfying a threshold amplitude change.

18. The device of claim 11, wherein the method further comprises:
determining, in the dataset, a potential exception field affected by the key fields; and
providing potential exception data associated with the potential exception field.

19. The device of claim 11, wherein the dataset is for storing data associated with a client device of a plurality of client devices, and the plurality of fields comprise a first plurality of attributes of the client device, a second plurality of attributes of an application installed to the client device, a third plurality of attributes of a data item published to the client device via the application, and a fourth plurality of events associated with the data item.

20. A non-transitory computer-readable storage medium, storing a computer program thereon, the computer program, when executed by a processor, causing the processor to implement a method, comprising:
determining a key field in a dataset, the dataset comprising a plurality of data sources, and respective data sources of the plurality of data sources respectively comprising at least one field;
obtaining a historical state of the key field in a historical time period;
in response to determining that the historical state indicates that a data change in the key field satisfies an exception condition, determining that the key field has a data exception, the data exception indicating that the key field has an exception in the historical time period; and
determining at least one cause field associated with the data exception in the dataset, a data exception of the at least one cause field resulting in a data exception of the key field.
